(19) United States
(12) Patent Application Publication
(10) Pub. No.: US 2008/0226093 A1
(43) Pub. Date: Sep. 18, 2008

(54) SPEAKER ARRAY APPARATUS AND SIGNAL PROCESSING METHOD THEREFOR

(75) Inventors: Koji KUSHIDA, Hamamatsu-shi (JP); Kenichi TAMIYA, Hamamatsu-shi (JP); Takashi YAMAKAWA, Iwata-shi (JP); Takao NAKAYA, Hamamatsu-shi (JP); Ken IWAYAMA, Hamamatsu-shi (JP)

Correspondence Address: ROSSI, KIMMS & McDOWELL LLP., P.O. BOX 826, ASHBURN, VA, 20146-0826, US

(73) Assignee: YAMAHA CORPORATION, Hamamatsu-shi (JP)

(21) Appl. No.: 12/044,603

(22) Filed: Mar. 7, 2008

(30) Foreign Application Priority Data
Mar. 12, 2007 (JP) 2007-061971

(51) Int. Cl. H04B 3/00

(52) U.S. Cl. 381/77

(57) ABSTRACT

A speaker array apparatus capable of performing control to narrow the directivity angle of low-frequency range sounds, without causing a speaker array to be large in size. An audio signal input to the speaker array apparatus is divided into an audio signal in which low-frequency range components of the input audio signal are included and an audio signal in which low-frequency range components thereof are attenuated, and the former audio signal is signal-processed by a directivity controller. Based on the processed audio signal, sounds are emitted from speakers disposed at four corners of the speaker array, whereby the directivity angle of acoustic beam in low-frequency range can be made narrower than when sounds are emitted from all the speakers of the speaker array.

### BACKGROUND OF THE INVENTION

1. Field of the Invention

The present invention relates to a speaker array apparatus with an improved directivity, and a signal processing method therefor.

2. Description of the Related Art

As a speaker system with an improved directivity or a narrow directivity, a speaker array having a plurality of speakers mounted thereon is known. The speaker array is adapted to control the amplitude, phase, and/or other characteristics of sound to be emitted from the speakers for control of a directivity state of sound, whereby beamed sound can be emitted toward a desired place. Since the beamed sound can be transmitted with less attenuation even to a remote place, the speaker array is often used in a large hall or the like.

As a result of the directivity state control, on the other hand, the sound frequency range is likely to be narrowed. To obviate this, the following exemplary documents disclose a technique to broaden the frequency range of sounds output from speakers. In this technique, high-frequency range sounds are emitted from small-sized speakers spaced at a narrow distance from one another, whereas low-frequency range sounds are emitted from large-sized speakers spaced at a wide distance. In other words, different types of speakers are selectively used for emission of different frequency range sounds, thereby performing directivity state control independently for respective frequency range sounds.

Japanese Laid-open Patent Publication No. 2006-67301

Tetsuki TANIGUCHI, Kiyoshi NISHIKAWA, and Masaki AMANO, Wideband Beamforming by Means of Multiple Band-Division Using Dolph-Chebyshev Spatial Filters, The Transactions of the Institute of Electronics, Information and Communication Engineers, December 1995, Vol. J78-A, No. 12, pp. 1576-1584

Mitsuyoshi OHYA, Kiyoshi NISHIKAWA, Directional Array Speaker with the Specified Beam Direction by means of a Band-Division Design, 10th Digital Signal Processing Symposium, Nov. 1-2, 1995, pp. 59-64

With the speaker array disclosed in Japanese Laid-open Patent Publication No. 2006-67301, low-frequency range sounds are emitted from speakers spaced at a wide distance, whereby control to narrow the directivity angle can be carried out. On the other hand, the speaker array becomes extremely large in size as a whole.

### SUMMARY OF THE INVENTION

The present invention provides a speaker array apparatus and a signal processing method therefor, which are capable of performing control to narrow the directivity angle of low-frequency range sounds, without causing a speaker array to be large in size.

According to a first aspect of the present invention, there is provided a speaker array apparatus having a plurality of signal processing units each adapted to perform signal processing on an audio signal supplied thereto and a plurality of speakers planarly disposed and each adapted to emit sound based on a signal output from a corresponding one of the plurality of signal processing units, comprising a signal supply unit adapted to supply a first audio signal to ones of the plurality of signal processing units which correspond to a speaker group including at least two of the plurality of speakers, the first audio signal including low-frequency range components of an audio signal input to the signal supply unit which fall within a frequency range including frequencies equal to or below a predetermined frequency, and a control unit adapted to cause the plurality of signal processing units to perform predetermined signal processing such that acoustic beam being emitted from the speaker group has a predetermined directivity angle, wherein the speaker group includes at least two of the plurality of speakers each two of which are spaced apart from each other at a distance equal to or greater than a predetermined length, and in a case where the speaker group includes at least three of the plurality of speakers, the speaker group includes the at least two of the plurality of speakers and at least further one of the plurality of speakers each of which is not disposed on a straight line connecting each two of the at least two of the plurality of speakers, and wherein the predetermined length is determined based on the predetermined frequency and the predetermined directivity angle.

In this invention, the speaker array apparatus can further include a signal divider unit adapted to divide an audio signal input thereto into the first audio signal and a second audio signal in which the low-frequency range components of the input audio signal falling within the frequency range including frequencies equal to or below the predetermined frequency are attenuated, and the signal supply unit can be adapted to supply the first audio signal from the signal divider unit to the signal processing units corresponding to the speaker group, and supply the second audio signal to other signal processing units than the signal processing units supplied with the first audio signal.

The plurality of speakers can include outer peripheralmost speakers, and the speaker group can include at least two of the outer peripheralmost speakers.

The speaker group can include two of the plurality of speakers which are spaced apart from each other at greatest distance among all of distances between respective ones of the plurality of speakers.

At least two of the plurality of speakers can be greater in diameter than others of the plurality of speakers, and the speaker group can include at least two of the at least two speakers which are greater in diameter than the others.

According to a second aspect of the present invention, there is provided a signal processing method for a speaker array apparatus having a plurality of signal processing units each adapted to perform signal processing on an audio signal supplied thereto and a plurality of speakers planarly disposed and each adapted to emit sound based on a signal output from a corresponding one of the plurality of signal processing units, comprising a signal supply step of supplying a first audio signal to ones of the plurality of signal processing units which correspond to a speaker group including at least two of the plurality of speakers, the first audio signal including low-frequency range components of an audio signal input to the signal supply step which fall within a frequency range including frequencies equal to or below a predetermined frequency, and a control step of causing the plurality of signal processing units to perform predetermined signal processing such that acoustic beam being emitted from the speaker group has a predetermined directivity angle, wherein the speaker group includes at least two of the plurality of speakers each two of which are spaced apart from each other at a distance equal to or greater than a predetermined length, and in a case where the speaker group includes at least three of the plurality of speakers, the speaker group includes the at least two of the plurality of speakers and at least further one of the plurality of speakers each of which is not disposed on a straight line connecting each two of the at least two of the plurality of speakers, and wherein the predetermined length is determined based on the predetermined frequency and the predetermined directivity angle.

According to the present invention, it is possible to provide a speaker array apparatus and a signal processing method therefor which are capable of performing control to narrow the directivity angle of low-frequency range sounds, without causing a speaker array to be large in size.

Further features of the present invention will become apparent from the following description of an exemplary embodiment with reference to the attached drawings.

### BRIEF DESCRIPTION OF THE DRAWINGS

FIG. 1 is a block diagram showing the construction of a speaker array apparatus according to one embodiment of this invention;

FIG. 2 is a perspective view showing the external appearance of a speaker array of the speaker array apparatus shown in FIG. 1;

FIG. 3 is a block diagram showing the construction of a selector shown in FIG. 1;

FIG. 4 is a block diagram showing a signal divider shown in FIG. 1;

FIG. 5A is a view showing a frequency-amplitude characteristic of a gain amplifier of the signal divider;

FIG. 5B is a view showing a frequency-amplitude characteristic of an HPF of the signal divider;

FIG. 6A is a view showing a result of calculation of a directivity state of acoustic beam;

FIG. 6B is a view showing a result of calculation of a directivity state of acoustic beam under a different condition;

FIG. 7 is a perspective view showing the construction of a speaker array according to a second modification of the embodiment;

FIG. 8 is block diagram showing the construction of a signal divider according to a third modification; and

FIG. 9 is a perspective view showing the construction of a speaker array according to a fifth modification.

### DETAILED DESCRIPTION OF THE PREFERRED EMBODIMENT

The present invention will now be described in detail below with reference to the drawings showing a preferred embodiment thereof.

### Embodiment

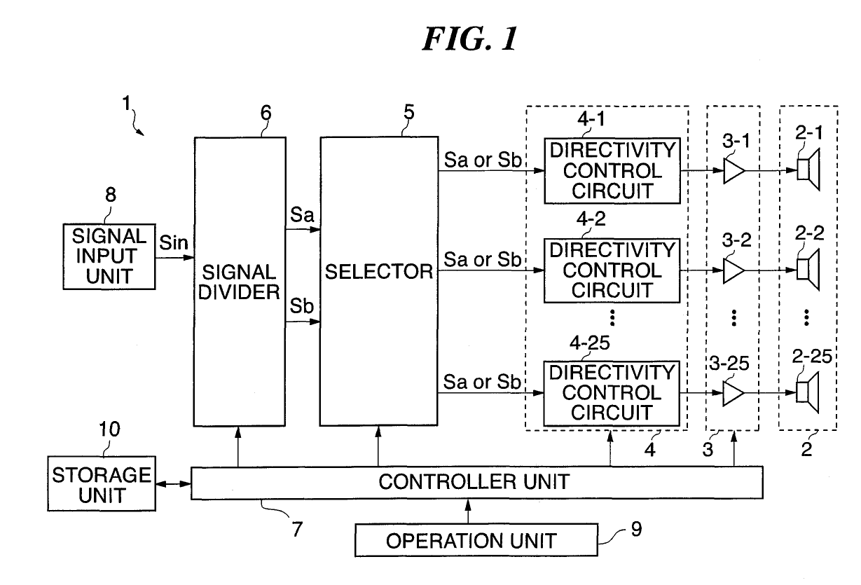

First, an explanation will be given of the construction of a speaker array apparatus 1 according to one embodiment of this invention. FIG. 1 shows in block diagram the speaker array apparatus 1 that includes a sound emission unit 2 having speakers 2-1 to 2-25.

The speaker array apparatus 1 includes an amplifier unit 3 having amplifiers 3-1 to 3-25 that amplify audio signals output from a directivity controller 4 with gains controlled by a controller unit 7. The amplified audio signals are output to respective ones of the speakers 2-1 to 2-25 connected to the amplifiers 3-1 to 3-25, respectively.

The directivity controller 4 includes directivity control circuits 4-1 to 4-25, in each of which an audio signal Sa or Sb output from a selector 5 is subjected to signal processing such as delay or amplification under the control of the controller unit 7. The processed signals are output from the directivity control circuits 4-1 to 4-25 to respective ones of the amplifiers 3-1 to 3-25 connected thereto. As a result of the signal processing in the directivity controller 4, sounds are emitted from the sound emission unit 2 as acoustic beam having a controlled directivity state. Specifically, the acoustic beam is emitted in a desired directivity direction with a predetermined directivity angle that provides a desired spread of acoustic beam. It should be noted that the directivity control circuits 4-1 to 4-25 can be comprised of FIR (finite impulse response) filters. In that case, signal processing on the audio signals output from the selector 5 can be carried out using coefficients set in the controller unit 7

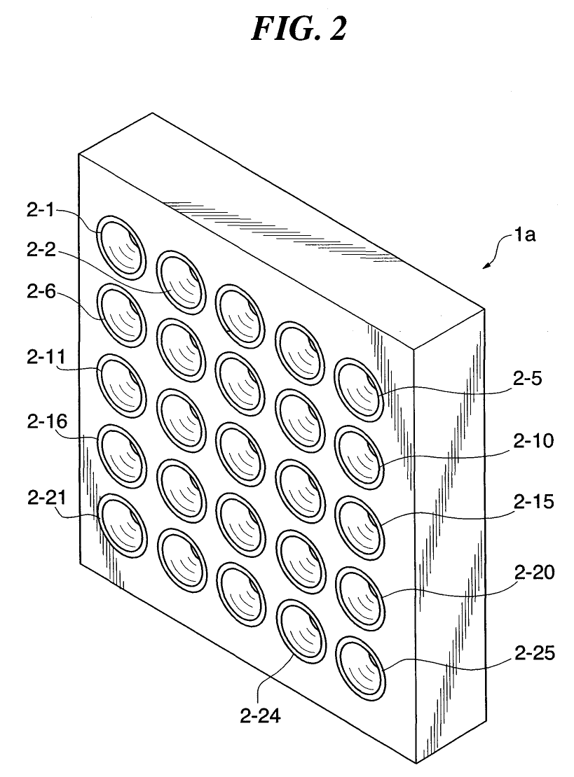

In this embodiment, the speaker array apparatus 1 includes twenty-five sets of directivity control circuits, amplifiers and speakers. As shown in FIG. 2, the speakers 2-1 to 2-25 of the speaker array apparatus 1 are disposed in five rows and five columns to constitute a speaker array 1a.

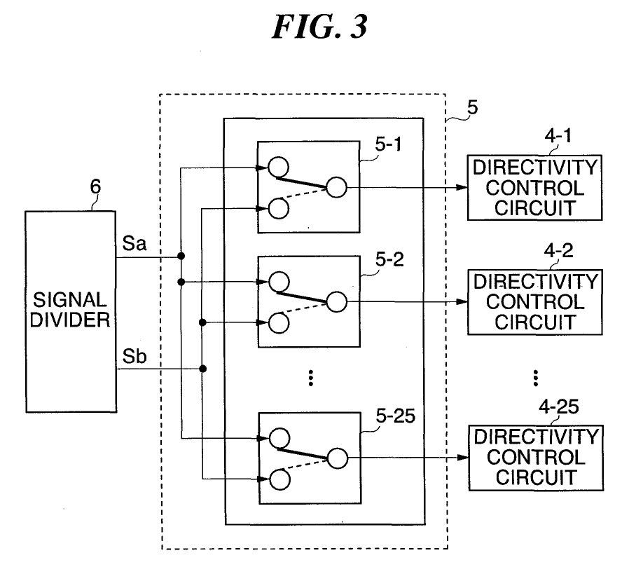

Under the control of the controller unit 7, the selector 5 selectively supplies each of the directivity control circuits 4-1 to 4-25 with either the audio signal Sa or Sb output from a signal divider 6. In this embodiment, the selector 5 is configured as shown in FIG. 3. Specifically, the selector 5 includes switches 5-1 to 5-25 each adapted to select either the audio signal Sa or Sb input thereto and supply the selected audio signal Sa or Sb to a corresponding one of the directivity control circuits 4-1 to 4-25 connected thereto. The audio signal selection by the switches 5-1 to 5-25 is carried out under the control of the controller unit 7. In this embodiment, the switches 5-1 to 5-25 are controlled such that the audio signal Sa is supplied to ones of the directivity control circuits which correspond to at least two of speakers disposed at an outer peripheral portion of the speaker array 1a.

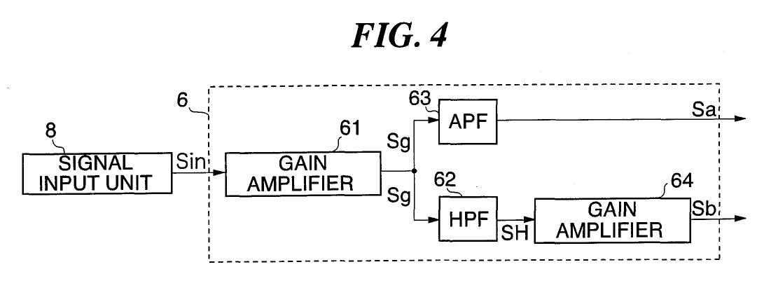

The signal divider 6 is adapted to divide an audio signal Sin input from a signal input unit 8 into the audio signals Sa and Sb, which are output to the selector 5. The audio signal Sa includes low-frequency range components of the audio signal Sin falling within a frequency range including frequencies equal to or lower than a predetermined frequency (hereinafter referred to as the cutoff frequency, which is 1 kHz in this embodiment). On the other hand, the low-frequency range components of the audio signal Sin are attenuated in the audio signal Sb. In this embodiment, the signal divider 6 is configured as shown in FIG. 4.

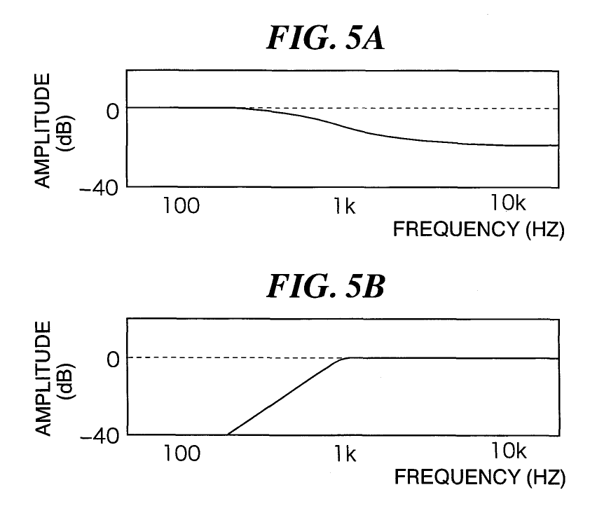

The signal divider 6 includes a gain amplifier 61, an HPF (high pass filter) 62, an APF (all pass filter) 63, and a gain amplifier 64. The gain amplifier 61 performs signal processing on the audio signal Sin input from the signal input unit 8 such as to change the amplitude of the audio signal Sin with a dependency on frequency, as shown in FIG. 5A. The resultant audio signal Sg is output to the HPF 62 and the APF 63. The HPF 62 performs signal processing on the audio signal Sg output from the gain amplifier 61 to attenuate the amplitude of low-frequency range components of the signal having frequencies equal to or below the cutoff frequency set to 1 kHz, as shown in FIG. 5B, and outputs the processed audio signal SH to the gain amplifier 64. The gain amplifier 64 amplifies, with a preset gain, the audio signal SH output from the HPF 62, and outputs the amplified audio signal Sb to the selector 5. On the other hand, the APF 63 performs signal processing on the audio signal Sg output from the gain amplifier 61 to change the phase thereof with a dependency on frequency, and outputs the processed audio signal Sa to the selector 5. It should be noted that the signal processing by the APF 63 is performed to change the phase of the audio signal Sg by an amount corresponding to a change in phase of the audio signal Sg caused by the signal processing by the HPF 62, whereby the audio signals Sa, Sb are made identical in phase. The amplification by the gain amplifier 64 is performed to compensate for a reduction in amplitude of those components of the audio signal Sin which fall within a frequency range including frequencies higher than the cutoff frequency, the reduction in amplitude of which being caused by the processing by the gain amplifier 61 on the audio signal Sin. The form or the like of the signal processing in the gain amplifier 61, the cutoff frequency, the gains, etc., which are parameters used by the signal divider 6, are set under the control of the controller unit 7.

As described above, the controller unit 7 controls various sections of the speaker array apparatus 1. Such control can be performed in accordance with instructions input by a user by operating the operation unit 9 or in accordance with preset values stored in the storage unit 10. The preset values stored in the storage unit 10 represent the directivity state and sound volume of acoustic beam, the cutoff frequency set in the HPF 62, the form of signal processing by the gain amplifier 61, the gain of the gain amplifier 64, the form of connections of the switches in the selector 5, and so on. In a case where plural sets of preset values are stored in the form of a lookup table in the storage unit 10, the controller unit 7 can control various sections of the speaker array apparatus 1 in accordance with that one of the plural sets of preset values stored in the storage unit 10 which is selected by the user by operating the operation unit 9.

In the following, an explanation is given of operation of the speaker array apparatus 1. First, the user operates the operation unit 9 to determine preset values to be used by the controller unit 7 to control various section of the speaker array apparatus 1. The controller unit 7 controls the various sections of the speaker array apparatus 1 in accordance with the determined preset values. The following is an explanation on a procedure performed from when an audio signal Sin is input from the signal input unit 8 to when sound is emitted from the sound emission unit 2.

The audio signal Sin input from the signal input unit 8 is output to the signal divider 6, in which the audio signal Sin is divided into an audio signal Sa, which includes low-frequency components of the audio signal Sin falling within a low-frequency range including frequencies equal to or below the cutoff frequency (1 kHz) set under the control of the controller unit 7, and an audio signal Sb in which the low-frequency components of the audio signal Sin are attenuated. The audio signals Sa, Sb are output to the selector 5.

The switches 5-1 to 5-25 of the selector 5 are controlled by the controller unit 7 such that the audio signal Sa is supplied to the directivity control circuits 4-1, 4-5, 4-21, and 4-25, whereas the audio signal Sb is supplied to the other directivity control circuits than the directivity control circuits 4-1, 4-5, 4-21, and 4-25. Specifically, the controller unit 7 controls the switches 5-1 to 5-25 of the selector 5 to supply the audio signal Sa to the directivity control circuits 4-1, 4-5, 4-21, and 4-25 corresponding to speakers 2-1, 2-5, 2-21, and 2-25 disposed at four corners of the speaker array 1a as shown in FIG. 2.

Under the control of the controller unit 7, each of the directivity control circuits 4-1 to 4-25 performs signal processing such as delay and amplification on the audio signal Sa or Sb supplied from the selector 5, and outputs the signal-processed audio signal Sa or Sb to a corresponding one of the amplifiers 3-1 to 3-25 connected thereto. Under the control of the controller unit 7, each of the amplifiers 3-1 to 3-25 amplifies the signal-processed audio signal Sa or Sb. Based on the amplified audio signals Sa, Sb, sounds are emitted from the speakers 2-1 to 2-25. As a result, an acoustic beam based on low-frequency range components of the audio signal Sin input to the speaker array apparatus 1 is emitted from the speakers 2-1, 2-5, 2-21, and 2-25, whereas an acoustic beam based on the audio signal Sin whose low-frequency components are attenuated in amplitude is emitted from the other speakers 2-2 to 2-4, 2-6 to 2-20, and 2-22 to 2-24.

As described above, in the speaker array apparatus 1, the input audio signal Sin is divided into the audio signal Sa in which low-frequency components thereof are included and the audio signal Sb in which low-frequency components thereof are attenuated, and the audio signal Sa is subjected to signal processing in the directivity controller 4. Based on the signal-processed audio signal Sa, sounds are emitted from the speakers 2-1, 2-5, 2-21, and 2-25 disposed at four corners of the speaker array 1a, whereby the directivity angle of the resulting acoustic beam in low-frequency range can be made narrower than that attained when such sounds are emitted from all the speakers 2-1 to 2-25 of the speaker array 1a.

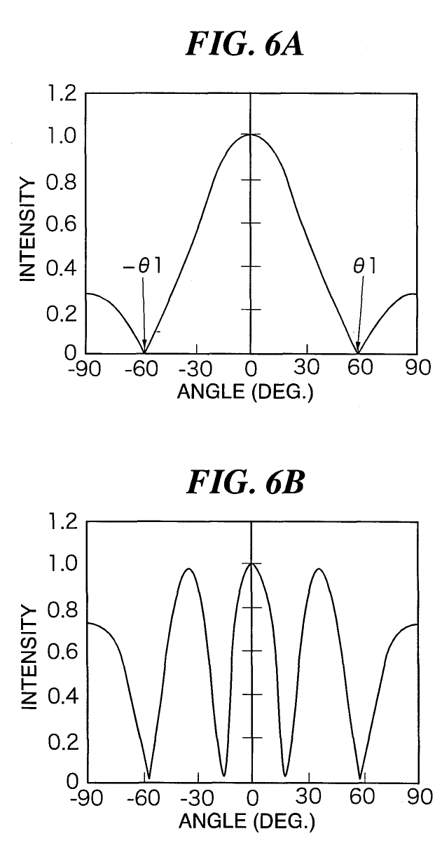

According to Toshiro OHGA, Yoshio YAMAZAKI, Yutaka KANEDA, Acoustic System and Digital Signal Processing, The Institute of Electronics, Information and Communication Engineers, 1993-05, PP. 176-186, an angle θ1 (see FIG. 6A) measured from an axis extending normal to a front surface of a one-dimensional speaker array, for example, at which the intensity of acoustic beam takes for the first time a value of zero is represented by the following formula (1).

θ1=Sin⁻¹ (c/(fdM)) (1),

where c denotes sound velocity; f, sound frequency; d, interspeaker distance; and M, the number of speakers.

By substituting, into formula (1), a distance L between outermost speakers disposed at opposite ends of the speaker array, which is represented by a relation L=d(M−1), the following formula (2) can be obtained.

θ1=Sin⁻¹ (c/(f(L+d))) (2)

As understood from formula (2), provided that the sound velocity f and the distance between the outermost speakers L remain constant, the greater the interspeaker distance d, the smaller the angle θ1 will be and the narrower a main lobe width of acoustic beam will be. Thus, the greater the interspeaker distance d, the narrower the directivity angle of acoustic beam will be. The interspeaker distance d increases with the decrease in the number of speakers M. In the speaker array where the number of speakers M is equal to or greater than two, the angle θ1 is minimized when the relation M=2, i.e., d=L, is satisfied. In that case, the following formula (3) is fulfilled.

θ1=Sin⁻¹ (c/2fL) (3)

On the other hand, if the interspeaker distance d is increased to an extent that the relation d<c/(2f) is not satisfied, grating lobes are generated as shown in FIG. 6B in accordance with the spatial sampling theorem, and acoustic beam is emitted in a plurality of directions. Therefore, as long as low-frequency range sounds concerned, it is preferable that the interspeaker distance d should be made large. On the other hand, in the case of the interspeaker distance d being fixed, it is preferable that an upper frequency limit of low-frequency range (corresponding to the cutoff frequency in this embodiment) should be set to be equal to a sound frequency f that satisfies the relation d<c/(2f).

As described above, the directivity control to narrow the directivity angle can be carried out by causing speakers between which the relation L=d is satisfied (in the embodiment, outer peripheralmost speakers in the speaker array 1a) to emit low-frequency range sounds rather than by causing all the speakers to emit such sounds.

In the above, the preferred embodiment of this invention has been described. This invention can also be embodied in various forms as described below.

### First Modification

In the embodiment, low-frequency range sounds are emitted from the outer peripheralmost speakers of the speaker array la, i.e., the speakers 2-1, 2-5, 2-21, and 2-25 disposed at four corners thereof. However, low-frequency range sounds can be emitted from other speaker than the speakers disposed at the four corners of the speaker array la. For example, low-frequency range sounds can be emitted from sixteen outer peripheralmost speakers, 2-1 to 2-6, 2-10, 2-11, 2-15, 2-16, and 2-20 to 2-25. In that case, the audio signal Sa is supplied from the selector 5 to directivity control circuits corresponding to the outer peripheralmost speakers. As a result, the volume level of low-frequency range sounds can be improved, while reducing influence on the directivity angle of acoustic beam being emitted.

Alternatively, low-frequency range sounds can be emitted from ten speakers 2-1 to 2-5 and 2-21 to 2-25 disposed on upper and lower edges of the speaker array 1a. In that case, a vertical interspeaker distance is larger than a horizontal interspeaker distance, and therefore the directivity angle in the vertical direction can be made narrower than that in the horizontal direction. Alternatively to the above described forms of sound emission, low-frequency range sounds can be emitted from the speakers 2-1 and 2-25. It should be noted that it is not inevitably necessary to cause low-frequency range sounds to be emitted from speakers disposed at the outer periphery of the speaker array la. For example, low-frequency range sounds can be emitted from speakers 2-6 and 2-25. As described above, at least two speakers spaced apart from each other at a distance equal to or greater than a predetermined length can be used for emission of low-frequency range sounds. In the case of three or more speakers being used for emission of low-frequency range sounds, if any of at least one further speaker is disposed on a straight line connecting each two of the at least two speakers, the resultant interspeaker distance becomes small. Thus, it is preferable that low-frequency range sounds should be emitted from the at least two speakers spaced apart at a distance equal to or greater than the predetermined length and at least one further speaker each of which is not disposed on a straight line connecting each two of the at least two speakers.

The above described predetermined length, which corresponds to the distance L between outermost speakers in formula (3) (i.e., the interspeaker distance d in the case of relation M=2 being met), can be determined based on a frequency range of emitted sounds (or the cutoff frequency) and a desired directivity angle of sounds in that frequency range. The predetermined length can directly be set by the user by operating the operation unit 9, or set by the controller unit 7 in accordance with the directivity angle and the cutoff frequency determined by the user by operating the operation unit 9. It is not inevitably necessary to emit low-frequency range sounds from outer peripheralmost speakers of the speaker array la, as described above, so long as a distance between each two speakers is equal to or larger than the predetermined length. In the case that a high cutoff frequency is set in the signal divider 6, an upper limit of the distance between two speakers can be set in order to prevent grating-lobe formation. If emission of low-frequency range sounds from, e.g., the speakers 2-1 and 2-25 is inappropriate for the reason that the distance therebetween exceeds the upper limit distance, low-frequency range sounds can be emitted from, e.g., the speakers 2-1 and 2-19 disposed at a distance smaller than the upper limit distance. In this way, the controller unit 7 is capable of variously controlling acoustic beam in low-frequency range to have a desired directivity state.

Second Modification

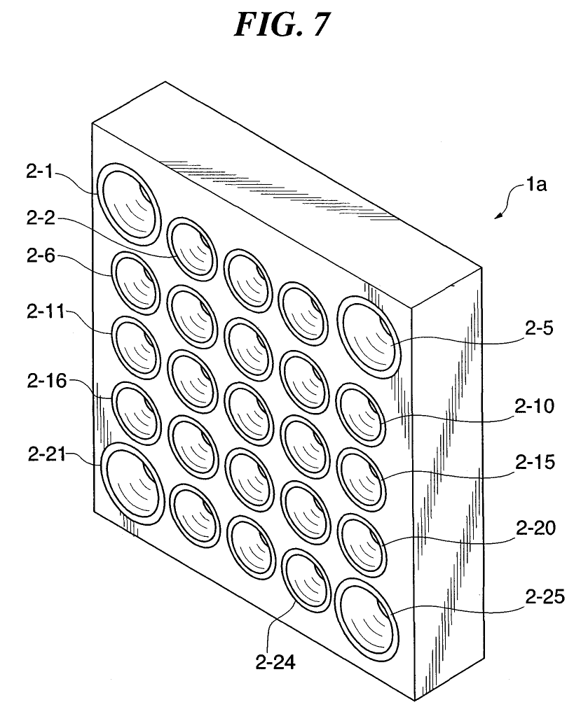

The speakers 2-1 to 2-25 of the embodiment are configured to have the same construction and performance, but can be configured to have different constructions and/or performances from one another. For example, in a case where the speakers 2-1, 2-5, 2-21, and 2-25 disposed at four corners of the speaker array 1a are used for emission of low-frequency range sounds, the speakers 2-1, 2-5, 2-21, and 2-25 can be large in diameter as shown in FIG. 7 to make it easy for these speakers to emit low-frequency range sounds, whereby the volume level of low-frequency range sounds can effectively be improved. It is not inevitably necessary to emit low-frequency range sounds, without modification, from the speakers which are large in diameter. For example, low-frequency range sounds attenuated in amplitude can be emitted therefrom. Furthermore, speakers used for emission of high-frequency range sounds can be configured to be small in diameter. In that case, it is preferable that the cutoff frequency set in the signal divider 6 should be equal to or higher than fundamental resonance frequencies of the speakers having the decreased diameters.

Third Modification

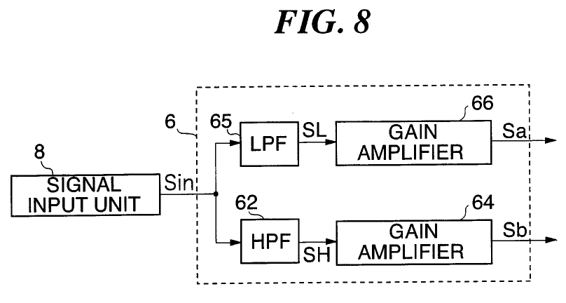

In the embodiment, the audio signal Sa output from the signal divider 6 includes all the frequency range components of the audio signal Sin input to the speaker array apparatus 1. Thus, the audio signal Sa overlaps the audio signal Sb in components falling within a frequency range including frequencies higher than the cutoff frequency. The audio signal Sa can be attenuated in amplitude of components thereof in a frequency range higher than the cutoff frequency so long as it includes low-frequency range components. In that case, the signal divider 6 can be configured as shown in FIG. 8. Specifically, an audio signal Sin input from the signal input unit 8 is subjected to signal processing by an LPF (low pass filter) 65 to attenuate the amplitude of components thereof in a frequency range higher than the cutoff frequency, and the resultant audio signal SL is output to a gain amplifier 66, in which the audio signal SL is amplified with a gain set in the controller unit 7, and the amplified audio signal Sa is output to the selector 5. As for the audio signal Sb, the audio signal Sin is subjected to the same signal processing as that in the HPF 62 and the gain amplifier 64 of the embodiment, and the resultant audio signal Sb is output to the selector 5. It should be noted that volume balance between sounds respectively falling in frequency ranges higher and lower than the cutoff frequency can be adjusted by changing gains set in the gain amplifiers 64 and 66. To this end, these gains can be calculated by the controller unit 7 in accordance with the number of speakers used for emission of low-frequency range sounds and the number of speakers used for emission of high-frequency sounds, and the volume balance adjustment can be made in accordance with a result of the calculation. In that case, effects similar to those attained by the embodiment can also be attained.

Fourth Modification

In the embodiment, under the control of the controller unit 7, the selector 5 selectively supplies either the audio signal Sa or Sb output from the signal divider 6 to each of the directivity control circuits 4-1 to 4-25, however, the form of audio signal selection in the selector 5 can be changed time-dependently. In that case, re-control means for re-controlling the selector 5 in predetermined timing can be provided in the controller unit 7. The predetermined timing can be determined by the user by operating the operation unit 9 or can be determined in advance. Furthermore, measuring means for measuring a frequency characteristic of the audio signal Sin input from the signal input unit 8 can be provided, and based on the frequency characteristic measured by the measuring means, the form of audio signal selection can be changed. For example, in the case of the audio signal Sin being small in amplitude in low-frequency range, the controller unit 7 can control the selector 5 to reduce the number of directivity control circuits to which the audio signal Sa is supplied. Furthermore, the controller unit 7 can control the selector 5 with reference to a target time-dependent change in audio signal selection form stored in the storage unit 10. In that case, an optimum form of audio signal selection can be determined in order to emit acoustic beam in a desired directivity state. In addition to the form of audio signal selection by the selector 5, the cutoff frequency set in the signal divider 6 can be changed on a time basis. Also in that case, the cutoff frequency can be re-set in predetermined timing by re-control means in the controller unit 7 as in the above described example. Furthermore, the directivity state of emitted acoustic beam can be changed time-dependently by changing parameters set in the directivity controller 4 on a time basis. Also in that case, the parameters in the directivity controller 4 can be re-set in predetermined timing by re-control means in the controller unit 7 as in the above described case.

Fifth Modification

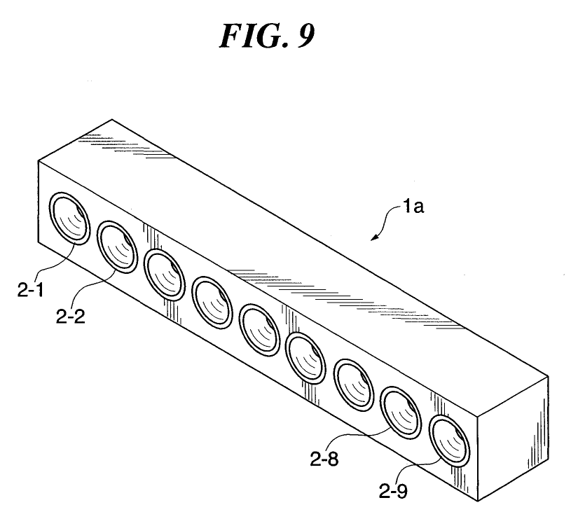

In the embodiment, the speakers 2-1 to 2-25 of the speaker array 1a are two-dimensionally disposed in rows and columns. Alternatively, speakers can one-dimensionally be disposed as shown in FIG. 9. In that case, the audio signal Sa including low-frequency range components of the input audio signal Sin is supplied to speakers disposed at opposite ends of the speaker array 1a (speakers 2-1 and 2-9 in the example shown in FIG. 9). Alternatively, the audio signal Sa can be supplied to any two of the speakers, e.g., speakers 2-2 and 2-9, so long as a distance therebetween is equal to or larger than the predetermined length. In that case, effects similar to or the same as those attained by the embodiment can also be attained.

What is claimed is:

1. A speaker array apparatus having a plurality of signal processing units each adapted to perform signal processing on an audio signal supplied thereto and a plurality of speakers planarly disposed and each adapted to emit sound based on a signal output from a corresponding one of the plurality of signal processing units, comprising:
a signal supply unit adapted to supply a first audio signal to ones of the plurality of signal processing units which correspond to a speaker group including at least two of the plurality of speakers, the first audio signal including low-frequency range components of an audio signal input to said signal supply unit which fall within a frequency range including frequencies equal to or below a predetermined frequency; and
a control unit adapted to cause the plurality of signal processing units to perform predetermined signal processing such that acoustic beam being emitted from the speaker group has a predetermined directivity angle,
wherein the speaker group includes at least two of the plurality of speakers each two of which are spaced apart from each other at a distance equal to or greater than a predetermined length, and in a case where the speaker group includes at least three of the plurality of speakers, the speaker group includes the at least two of the plurality of speakers and at least further one of the plurality of speakers each of which is not disposed on a straight line connecting each two of the at least two of the plurality of speakers, and
wherein the predetermined length is determined based on the predetermined frequency and the predetermined directivity angle.

2. The speaker array apparatus according to claim 1, further including:
a signal divider unit adapted to divide an audio signal input thereto into the first audio signal and a second audio signal in which the low-frequency range components of the input audio signal falling within the frequency range including frequencies equal to or below the predetermined frequency are attenuated,
wherein said signal supply unit is adapted to supply the first audio signal from said signal divider unit to the signal processing units corresponding to the speaker group, and supply the second audio signal to other signal processing units than the signal processing units supplied with the first audio signal.

3. The speaker array apparatus according to claim 1, wherein the plurality of speakers include outer peripheralmost speakers, and the speaker group includes at least two of the outer peripheralmost speakers.

4. The speaker array apparatus according to claim 1, wherein the speaker group includes two of the plurality of speakers which are spaced apart from each other at greatest distance among all of distances between respective ones of the plurality of speakers.

5. The speaker array apparatus according to claim 1, wherein at least two of the plurality of speakers are greater in diameter than others of the plurality of speakers, and
the speaker group includes at least two of the at least two speakers which are greater in diameter than the others.

6. A signal processing method for a speaker array apparatus having a plurality of signal processing units each adapted to perform signal processing on an audio signal supplied thereto and a plurality of speakers planarly disposed and each adapted to emit sound based on a signal output from a corresponding one of the plurality of signal processing units, comprising:
a signal supply step of supplying a first audio signal to ones of the plurality of signal processing units which correspond to a speaker group including at least two of the plurality of speakers, the first audio signal including low-frequency range components of an audio signal input to said signal supply step which fall within a frequency range including frequencies equal to or below a predetermined frequency; and
a control step of causing the plurality of signal processing units to perform predetermined signal processing such that acoustic beam being emitted from the speaker group has a predetermined directivity angle,
wherein the speaker group includes at least two of the plurality of speakers each two of which are spaced apart from each other at a distance equal to or greater than a predetermined length, and in a case where the speaker group includes at least three of the plurality of speakers, the speaker group includes the at least two of the plurality of speakers and at least further one of the plurality of speakers each of which is not disposed on a straight line connecting each two of the at least two of the plurality of speakers, and
wherein the predetermined length is determined based on the predetermined frequency and the predetermined directivity angle.
